(19) United States
(12) Patent Application Publication
(10) Pub. No.: US 2011/0016104 A1
(43) Pub. Date: Jan. 20, 2011

(54) Centralized web-based system for automatically executing search engine optimization principles for one, or more website(s)

(75) Inventor: Michel Roger Pierre Leconte, San Francisco, CA (US)

Correspondence Address: Michel Leconte, 827 Shrader Street, San Francisco, CA, 94117, US

(73) Assignee: SEO Samba, Corp., Dover, DE (US)

(21) Appl. No.: 12/502,971

(22) Filed: Jul. 14, 2009

(51) Int. Cl. G06F 17/30

(52) U.S. Cl. 707/706; 707/E17.108

(57) ABSTRACT

A system and method to optimize one or more website's organic listing at one or more search engine engines is described. Several embodiments include methods and systems for building and applying customizable website search engine optimization best practice rules, thereby modifying data associated with one or more websites to achieve a desired result. The desired result, which is augmented/compounded by the greater number of websites using the system and method, is an improvement of the organic ranking of the website(s) with respect to one or more search engines.

### FIELD OF THE INVENTION

The invention relates to, among other things, methods and systems for optimization of websites (“sites”) with respect to organic search results generated by search engines in response to user queries. In particular, but not by way of limitation, aspects of the invention pertain to one or more centralized web-based software solutions that implements search engine optimization best practices rules across one or more websites. The result, which is augmented/compounded by the number of websites using the invention, is a modification to a parameter of the website in order to improve an organic ranking of the website with respect to one or more search engines.

### BACKGROUND OF THE INVENTION

With the growth of search engines, business entities (e.g., companies) are dedicating greater portions of their marketing budgets to search engine optimization (SEO) initiatives. Typically, SEO initiatives are driven by “organic” search results. In this regard, the organic listing of a website (“site”) pertains to the relative ranking of that site in the algorithmic results generated by a particular search engine on the basis of particular keywords. This contrasts with sponsored or paid search results which are often listed proximate such organic search results and which list sites that have compensated the operator of the search engine for such listing. For various strategic reasons, including increasing of inbound leads and sales, a business entity may drive content of a site it owns or operates so that the site appears in organic search results created by one or more search engines. With respect to implementing SEO initiative, previously-known technology does not enable large scale domain owners or operators (e.g., an enterprise-scale business entity; a SEO agency; an affiliate network operator; an industry-focused web development firm; a franchisor; an online yellow pages, local search or directory publisher) to execute organic search engine optimization best practices associated with various search engines in an automated, consistent and scalable fashion across a large portfolio of websites domain. Furthermore, previously-known technology does not effectively allow a business entity to leverage the number of domains and websites they own or operate in order to improve their organic rankings with search engines. In addition, previously-known technology does not effectively allow business entities operating single website or smaller size websites portfolio to execute automatically search engine optimization principles and pull together in order to benefit from the network effect enjoyed by larger domain portfolio operators.

### SUMMARY OF THE INVENTION

Exemplary embodiments of the invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In one aspect, the invention provides a system and method for modifying one or more features of a website in order to optimize the website in accordance with an organic listing of the website at one or more search engines. The inventive systems and methods include constructing a plurality of search engine optimization rules. Such rule may include, for example, data related to the construction of the website and/or data related to the traffic of one or more visitors to the website and/or a search engine queries file. The rules may be combined with each other to achieve a result that modifies website's features to optimize a ranking of the website with respect to the organic listing of the website at one or more search engines.

In one embodiment, for example, the rules may be combined with data originating from other system's users and websites. Upon applying these rules, both website and other system's users and websites data may be modified to achieve a result that optimize a ranking of the website with respect to the organic listing of the website at one or more search engines.

### BRIEF DESCRIPTION OF THE DRAWINGS

Various objects and advantages and a more complete understanding of the invention are apparent and more readily appreciated by reference to the following Detailed Description and to the appended claims when taken in conjunction with the accompanying Drawings wherein:

FIG. 1 shows a block diagram depicting a typical network system for executing search engine optimization of a website.

FIG. 2 illustrates one implementation of a search engine optimization execution system.

FIG. 3 depicts a process flow diagram illustrating steps taken by a software solution in accordance with one embodiment of the invention;

FIG. 4 illustrates a first user interface that may be presented to a user when configuring client-pertinent search engine optimization in accordance with certain aspects of the invention;

FIG. 5 illustrates a second user interface that may be presented to a user when configuring client-pertinent search engine optimization in accordance with certain aspects of the invention;

FIG. 6 illustrates a third user interface that may be presented to a user when representing search engine optimized links across client-pertinent websites developed during linear and/or non-linear combinations in accordance with certain aspects of the invention; and

FIG. 7 illustrates a fourth user interface that may be presented to a user when representing client-pertinent information about search engines and search engine optimized code for one or more websites and developed during linear and/or non-linear combinations in accordance with certain aspects of the invention; and

FIG. 8 shows a block diagram depicting an alternative system for executing search engine optimization of a website.

### DETAILED DESCRIPTION OF EMBODIMENTS OF THE INVENTION

The invention relates to, among other things, methods and systems for optimization of websites (“sites”) to enhance organic search results generated by search engines in response to user queries. Several embodiments of the invention pertain to one or more centralized web-based software solutions that optimize for search engines a plurality of websites of a plurality of business entity in an automated fashion. More specifically, embodiments of the software solutions may construct custom search engine optimization (SEO) rules, combine data with other system's users and websites, execute a plurality of SEO rules to implement or modify a plurality of parameters of the website in order to improve an organic ranking of the website with respect to one or more search engines.

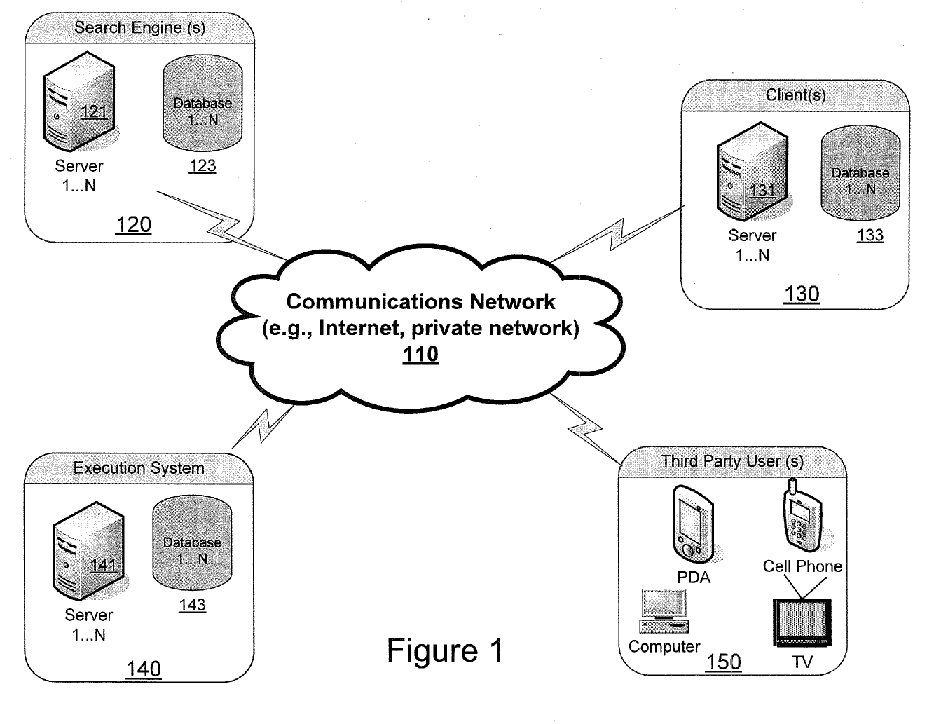

Aspects of the invention are designed to operate on computer systems, servers, and/or other like devices. While the details of embodiments of the invention may vary and still be within the scope of the claimed invention, FIG. 1 shows a block diagram depicting a typical network system 100 for executing SEO best practices in accordance with the invention. The network system 100 is only one example of a suitable computing environment and is not intended to suggest any limitation as to the scope of use or functionality of the invention. Neither should the network system 100 be interpreted as having any dependency or requirement relating to any one or combination of components illustrated in the exemplary network system 100.

Aspects of the invention may be described in the general context of computer-executable instructions, such as program modules, being executed by a computer or server. Generally, program modules include routines, programs, objects, components, data structures, and the like that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

As is shown, the network system 100 includes a communications network 110, such as the Internet or a private network, capable of providing communication between devices at search engine(s) 120, advertiser/client(s) 130, a multi-sites SEO execution system 140, and third party user(s) 150 described hereinafter. The devices of FIG. 1 communicate with each other via any number of methods known in the art, including wired and wireless communication pathways.

As shown in FIG. 1, a search engine 120 is accessible by a third party user 150, a client 130, and by the multi-sites SEO execution system 140. The third party user 150 may utilize any number of computing devices that are configured to retrieve information from the World Wide Web (“WWW”), such as a computer, a personal digital assistant (PDA), a cell phone, a television (TV), and other network communications-enabled devices. The client 130 is typically a business entity with one or more websites that are to be indexed by a search engine 120 or a social network. The multi-sites execution system 140 operates one or more servers 141 capable of Internet-based communication with the search engine 120 and the client 130. As is discussed below, the multi-sites execution system 140 enables the client 130 to construct and automatically execute SEO rules and best practices with respect to websites owned and operated by the client 130 and/or entities other than the clients 130. It is a feature of embodiments of the invention that these automation routines enable the client 130 to quickly implement marketing efficiencies and/or opportunities.

As those skilled in the art will appreciate, various intermediary network routing and other elements between the communication network 110 and the devices depicted in FIG. 1 have been omitted for the sake of simplicity. Such intermediary elements may include, for example, the public-switched telephone network (PSTN), gateways or other server devices, and other network infrastructure provided by Internet service providers (ISPs).

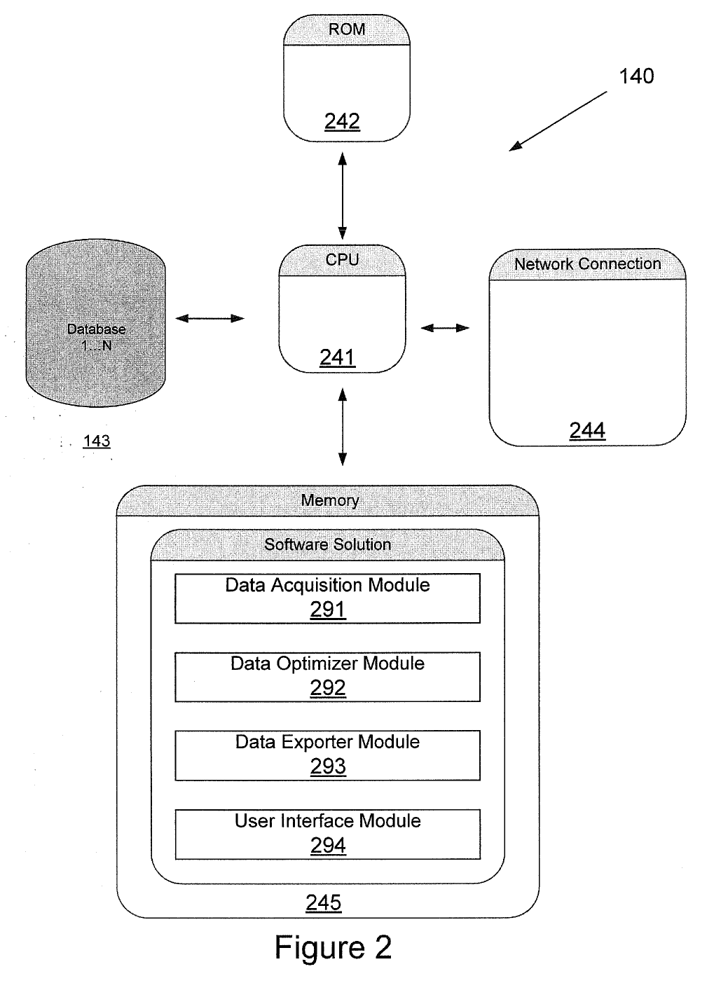

Attention is now drawn to FIG. 2, which depicts one implementation of the multi-sites SEO execution system 140. As is shown, the multi-sites SEO execution system 140 may include, but not by way of limitation, a processor 241 coupled to ROM 242, the database 143, a network connection 244, and memory 245 (e.g., random access memory (RAM)).

The database 143 is described herein in several implementations as hard disk drive for convenience, but this is certainly not required, and one of ordinary skill in the art will recognize that other storage media may be utilized without departing from the scope of the invention. In addition, one of ordinary skill in the art will recognize that the database 143, which is depicted for convenience as a single storage device, may be realized by multiple (e.g., distributed) storage devices.

As shown, a software solution 290 includes a data acquisition module 291, a data optimizer module 292, a data exporter module 293, and a user interface (“UI”) module 294, all of which are implemented in software and are executed from the memory 245 by the processor 241. The solution 290 can be configured to operate on personal computers (e.g., handheld, notebook or desktop), servers or any device capable of processing instructions embodied in executable code. Moreover, one of ordinary skill in the art will recognize that alternative embodiments, which implement one or more components of the invention in hardware, are well within the scope of the invention. Each module 291-294 is associated with one or more functions of the invention describe herein.

Basic Operation of the Software Solution

In general terms, the solution 290 construct and/or modify website (“Site”) to maximize site's organic ranking with respect to one or more search engines. The solution 290 may modify website data to improve its construction. For example, the solution 290 may construct website URL's based on webpage's targeted keywords. Additionally, the solution 290 may construct page's title, meta content and headers based on keywords. The solution 290 may also implement keywords-driven links with other solution's users and websites thereby augmenting effectiveness with respect to the organic ranking of a site. The solution 290 may also optimize websites based on data from search engine, directories, and media outlets with respect to the organic ranking of a site. Media outlets may include data feeds, results from an API call and imports of files received as reports offline (i.e., not over the Internet) that pertain to social profiles (e.g. facebook), business networks (e.g. LinkedIn), blogging platforms (e.g. Twitter, WordPress) and the like. One of skill in the art will appreciate alternative implementations.

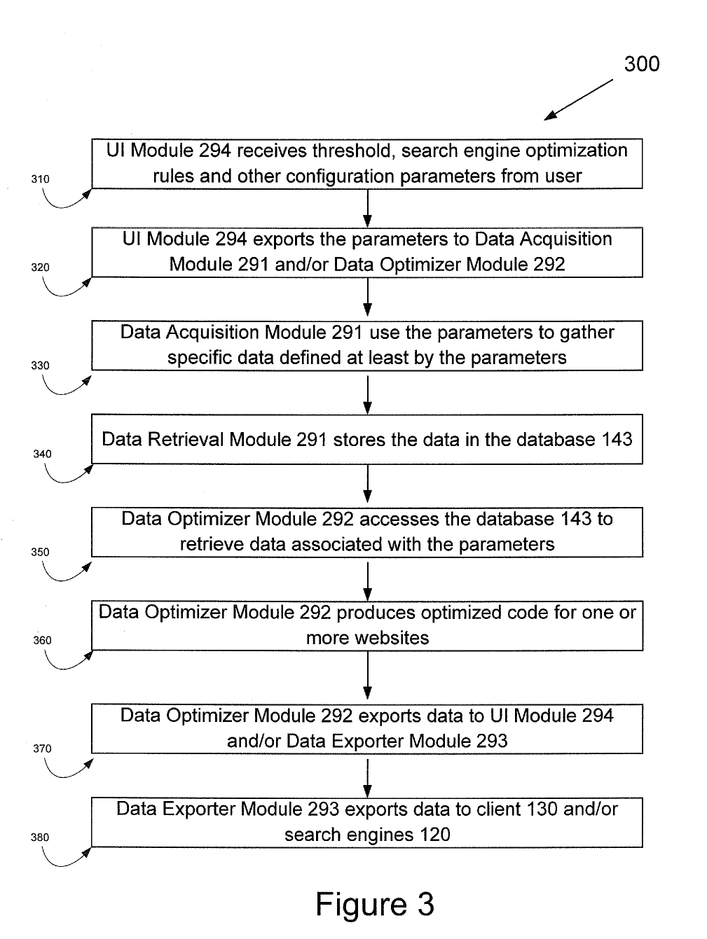

The modules 291-294 operate in concert with each other to perform certain functions of the solution 290. By way of example, FIG. 3 depicts a process flow diagram 300 illustrating steps taken by the solution 290 in accordance with one embodiment of the invention. As shown in step 310, the UI module 294 may receive filtering and configuration parameters from a user (e.g., an agency, a system administrator, the client 130, etc.). The UI module 294, in step 320, may export those parameters to the data acquisition module 291 and/or the data optimizer module 292. The parameters may pertain to system administration parameters that apply to general implementations of the solution 290 (e.g., pre-configured best practices) or to user parameters that apply to specific implementations of the solution 290 (e.g., custom best practices, data collection). The data acquisition module 291, in step 330, uses the parameters to gather specific data defined at least in part by the parameters. The data acquisition module 291 may gather data from one or more search engine files, one or more content source files (e.g., video, image, document and various other non-html files), one or more web files associated with the client(s) 130, and/or one or more web analytics system files. Upon gathering data, the data acquisition module 291, in step 340, stores the data in the database 143. The data optimizer module 292, in step 350, accesses the database 143 to retrieve data associated with the parameters, and then, in step 360, produces optimized code for one or more websites. In step 370, the optimized data sets may be exported to the UI module 294, which displays one or more visual representations of the optimized code to the user and/or to the data exporter module 293. The data exporter module 293, in step 380, may export optimized websites data from solution 290 to this or any other client 130 and/or search engines 120.

Data Acquisition Module

The data acquisition module 291 gathers data for use by the optimizer module 292 in executing one or more SEO rules that are visually represented via the UI module 294. The data may be gathered from any number of sources, including by way of example, one or more search engines (e.g., the search engines 120), one or more content sources (e.g., one or more videos, images and/or documents such as .pdf, .doc, and .xls files, among others)), one or more sites associated with the client(s) 130, and/or one or more web analytics systems.

For example, the data collected by the data acquisition module 291 may include all pages from one or more sites associated with the client(s) 130, and/or page-level data, including URL's, page titles, meta content and/or headers. The data acquisition module 291 may also collect data associated with a website last indexation by one or more search engines or social networks. Alternatively or additionally, data pertaining to whether one or more keywords are found in a page's title, meta content and/or headers may be collected. One of skill in the art will recognize that the data acquisition module 291 may collect data specific to any type of page, including preferred landing pages, video, social profiles, blogging (e.g. WordPress) updates, micro-blogging (e.g.; Twitter) updates, and more.

Additional data collected by the data acquisition module 291 may include search engine keywords popularity statistics, and/or rankings or a number of ranked positions of one or more pages or sites with respect to one or more organic search engine results that are based on one or more search terms (e.g., one or more keywords) during one or more time periods.

One of skill in the art will appreciate alternative forms of data within both the scope and spirit of the invention that the data acquisition module 291 may gather, including additional web analytics data and/or data accessible via application programming interfaces (APIs) associated with search engines.

Data Optimizer Module

Attention is drawn to the reports module 292 of FIG. 2, which functions to receive parameters from the UI module 294, retrieve data from the database 143, execute one or more SEO rules based on the parameters and the retrieved data, and then send the optimized data to the UI module 294 and/or data exporter module 293. The data optimizer module 292 automates the implementation of a plurality of SEO rules (e.g., the rule is executed when page content is modified). When executing SEO rules, the data optimizer module 292 may use one or more linear and/or non-linear combinations involving one or more websites of one or more client(s) 130 in order to improve an organic ranking of the website with respect to one or more search engines.

The data optimizer module 292 may combine websites data with software solutions' websites and users based on, by way of example, but not by way of limitation, identified related industry, language, audience targeted geographical area, and web pages content and concepts, among others, and execute specific search engine optimization rules across software solution's websites and users in order to improve an organic ranking of the website with respect to one or more search engines.

A SEO rule may be a generalization of how a parameter or feature of a site may be modified to optimize the site with respect to an organic ranking of the site at a search engine. By way of example, in one embodiment a parameter may be how a webpage URL's include the keywords targeted for optimization with respect of the site's organic ranking in search engine results. In another embodiment, a parameter may be what anchor texts are deemed suitable for a webpage's inbound links across software solution's users and websites. In yet another embodiment, a feature may be how a plurality of parameters are constructed in relation to each others, including but not limited to page title, navigation, meta content, H1 tags. In yet another embodiment, a feature may construct XML sitemap, prepare requests to search engines for increasing site's crawling rate, implement news search engine compliant site construction, and build optimized RSS feeds. One of skill in the art will appreciate various other features that may be indicated using configurable rules, including any of the ‘Collected Data’ described below with respect to Table 1.

As stated above, the data optimizer module 292 may employ computations that are configurable, via the UI module 294, in terms of semantic, variables, mathematical and threshold combinations. Additionally, the data optimizer module 292 may be configured to operate in terms of one or more instances or periods of time (e.g., date ranges, triggered events). One of skill in the art will appreciate that any number of combinations of any number of variables may be used to construct SEO data pertinent to the client 130.

By way of example, Table 1 displays a listing of data, and high-level method applied to construct search engine optimized version of the data.

As shown in Table 1, data v30, a user LinkedIn profile may be optimized by using targeted keywords as a custom LinkedIn URL, and featured links anchor text may be created based on preferred landing page and optimized with associated targeted keywords. The LinkedIn profile may then be updated with optimized news item snippets whenever updates are brought to the site.

| | Data | Search Engine Optimized Data |
|---|---|---|
| V₁ | News item | Create news page date and timestamp |
| | | automatically, along with Google news compliant |
| | | URL and store within keyword-rich folder. |
| V₂ | News scroller | Create search bots friendly scroller. Bots can |
| | | follow links. |
| V₃ | News archive | Retain original URL when archived. |
| V₄ | RSS feed | Creates full, snippets, and category specific RSS |
| | | feeds. |
| V₅ | RSS bug tracker | Creates an image file to monitor subscriptions. |
| V₆ | Newsletter | Adds ′newsletter′ and ′email′ UMT code to URL, |
| | tracking | leaving only two fields to populate. |
| V₇ | XML News | Referenced in XML sitemap index and uploaded |
| | Sitemap | to Google WMT after each site upload. |
| V₈ | XML Sitemap | Uploaded to Google WMT after each site upload. |
| | Index | |
| V₉ | XML Web | Uploaded to Google WMT after each site upload. |
| | Sitemap | |
| V₁₀ | Robots.txt | Auto-created by system. Check for possible error |
| | | preventing indexation prior uploading. |
| V₁₁ | HTML Sitemap | Created automatically by system with No Follow |
| | | tags for appropriate pages. |
| V₁₂ | Web analytics | Add tags automatically, and prevent conflicts. |
| | code | |
| V₁₃ | Create landing | Add tags automatically, and prevents page test |
| | page experiment | conflict mistakes. |
| V₁₄ | Delete landing | Remove tags and create redirection orders |
| | page experiment | automatically to retain traffic |
| V₁₅ | Client Deep Links | Create links automatically on client sites based |
| | | on target page anchor text, content and meta |
| | | content attributes. Update links automatically |
| | | any time content is modified. |
| V₁₆ | Partner Deep Links | Parse, and create links automatically on |
| | | partner sites based on target page anchor text, |
| | | content and meta content attributes. |
| V₁₇ | Internal link equity | Create No Follow tags automatically for |
| | management | secondary pages in order to focus link equity |
| | | on competitive pages. |
| V₁₈ | External link | Create No Follow tags automatically for |
| | equity management | outbound pages based on user |
| | | parameters, search engine ranking and search |
| | | engine indicators. |
| V₁₉ | Page targeting | Creates link equity friendly permanent 301 |
| | change | redirect automatically upon 1) change of page |
| | | URL/targeting, and 2) URL imports. |
| V₂₀ | Meta Description | Populated automatically based on page content |
| | | and other system variables as configured by user. |
| V₂₁ | Meta Keywords | Populated automatically based on page content |
| | | and other system variables as configured by user. |
| V₂₂ | Page title tag | Populated automatically based on page targeting |
| | | and other system variables as configured by user. |
| V₂₃ | Page Header | Populated automatically based on page targeting |
| | | and other system variables as configured by user. |
| V₂₄ | Page URL | Built automatically based on page targeting and |
| | | other system variables as configured by user. |
| V₂₅ | Page Content | Bold content to re-enforce page focus. Add image |
| | | alt and flash advisory tags automatically based |
| | | respectively on image file name and page header. |
| V₂₆ | Google business | Create profile automatically based on site profile |
| | center listing | information, marketing snippet, and preferred |
| | | landing page. |
| V₂₇ | Yahoo business | Create profile automatically based on site profile |
| | center listing | information, marketing snippet, and preferred |
| | | landing page. |
| V₂₈ | MS Live business | Create profile automatically based on site profile |
| | center listing | information, marketing snippet, and preferred |
| | | landing page. |
| V₂₉ | Twitter profile | Create profile automatically based on site |
| | | graphical template, profile information, |
| | | marketing snippet, and preferred landing page. |
| | | Automate updates based on new page creation |
| | | and news page releases. |
| V₃₀ | LinkedIn profile | Optimize profile's URL and featured links based |
| | | on keyword targets, and preferred landing page. |
| | | Update profile automatically with news snippets. |

Data Exporter Module

The data exporter module 293 export data generated by the optimizer module 292 based at least in part on parameters received by the UI module 294. The data may be exported to any number of sources, including by way of example, one or more search engines, directories and social websites (e.g., the search engines 120), one or more sites associated with the client(s) 130, and/or one or more web analytics systems.

For example, the data exported by the data exporter module 293 may include all pages from one or more sites associated with the client(s) 130, and/or page-level data, including URL's, page titles, meta content and/or headers. The data exporter module 293 may also export data previously collected by the data importer module 291 and associated with a website by one or more search engines or social networks. Alternatively or additionally, data pertaining to whether one or more keywords are found in a page's title, meta content and/or headers may be exported. One of skill in the art will recognize that the data exporter module 293 may export data specific to any type of page, including preferred landing pages, video, social profiles, blogging (e.g. WordPress) updates, micro-blogging (e.g.; Twitter) updates, and more.

Additional data exported by the data exporter module 291 may include search engine keywords popularity statistics, and/or rankings or a number of ranked positions of one or more pages or sites with respect to one or more organic search engine results that are based on one or more search terms (e.g., one or more keywords) during one or more time periods.

One of skill in the art will appreciate alternative forms of data within both the scope and spirit of the invention that the data exporter module 293 may export, including additional data accessible via application programming interfaces (APIs) associated with search engines.

User Interface (“UI”) Module

The UI module 294 receives filtering and customization parameters from a user, sends at least a portion of those parameters to the data acquisition module 291 and/or the data optimizer module 292 and/or data exporter module 293, receives one or more data set from the data acquisition module 291 and/or data exporter module 293 and/or the data optimizer module 292. The UI module 294 displays one or more visual representations of the data set(s) received from the data acquisition module 291 and/or the data optimizer module 292 and/or data exporter module 293. The visual representations may be formed of alphanumerical, color-coded, graphical, image-based, or any other type of representation.

At least a portion of the filtering parameters received by the UI module 294 define the scope of data collection by the data acquisition module 291 and/or data retrieval by the data optimizer module 292. For example, the parameters may define the scope of data collection and/or data retrieval in terms of one or more instances or periods of time (e.g., date ranges, triggered events). Alternatively or additionally, the parameters may define the scope of data collection and/or data retrieval in terms of the types of data previously described with respect to the data acquisition module 291.

At least a portion of the customization parameters define how SEO best practices are applied by the data optimizer module 292. The customization parameters allow a user to configure how SEO rules are constructed and to what sites they may apply. Customization parameters may include parameters similar to those described above with respect to the filtering parameters. Additionally, the customization parameters may include on/off switches, checkboxes, pull-down menus, text edit boxes, drill-down, online analytical processing (OLAP), research and sorting parameters (e.g., ascending or descending organization), as well as display parameters (e.g., numeric, color-coded, or video/image representation display parameters).

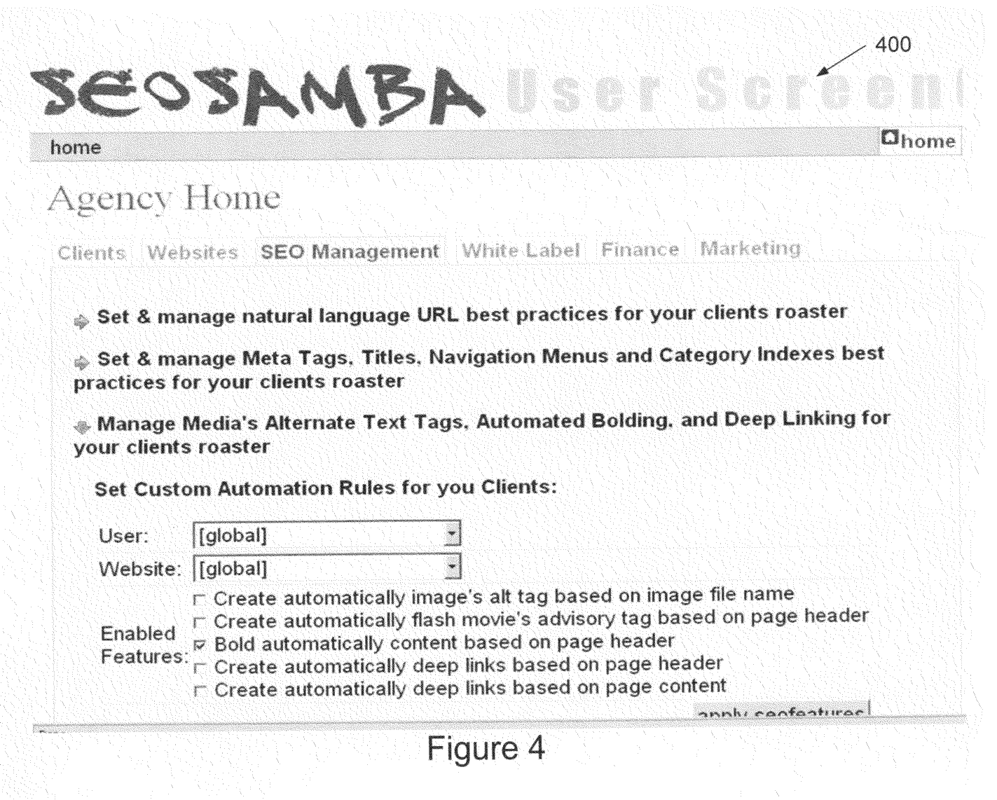

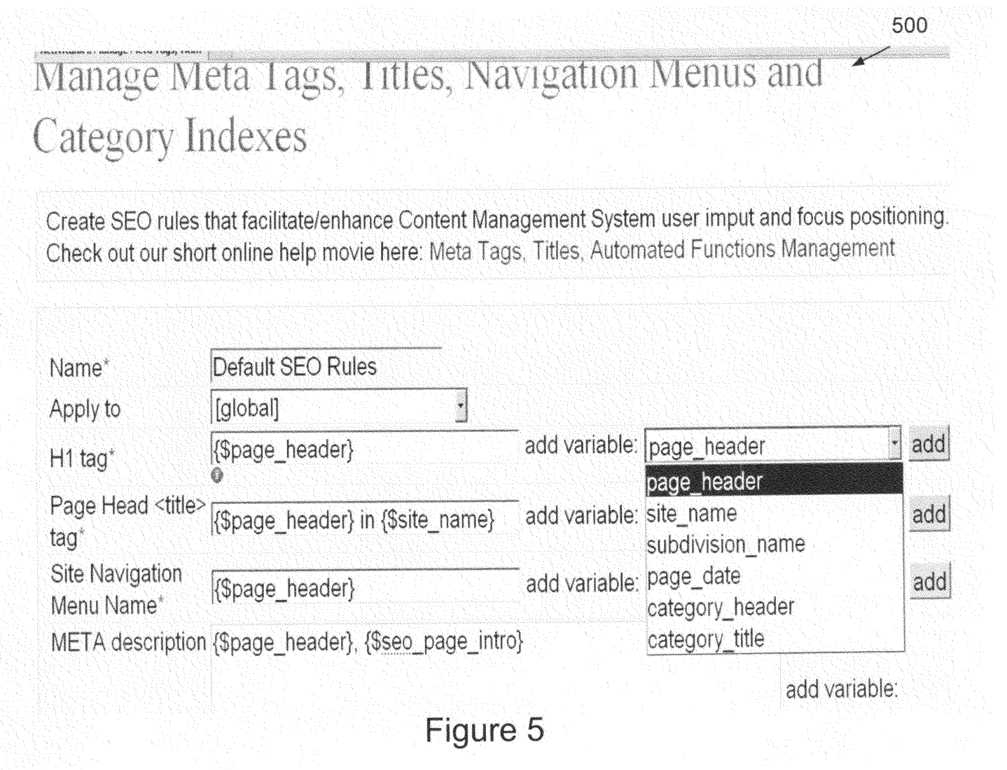

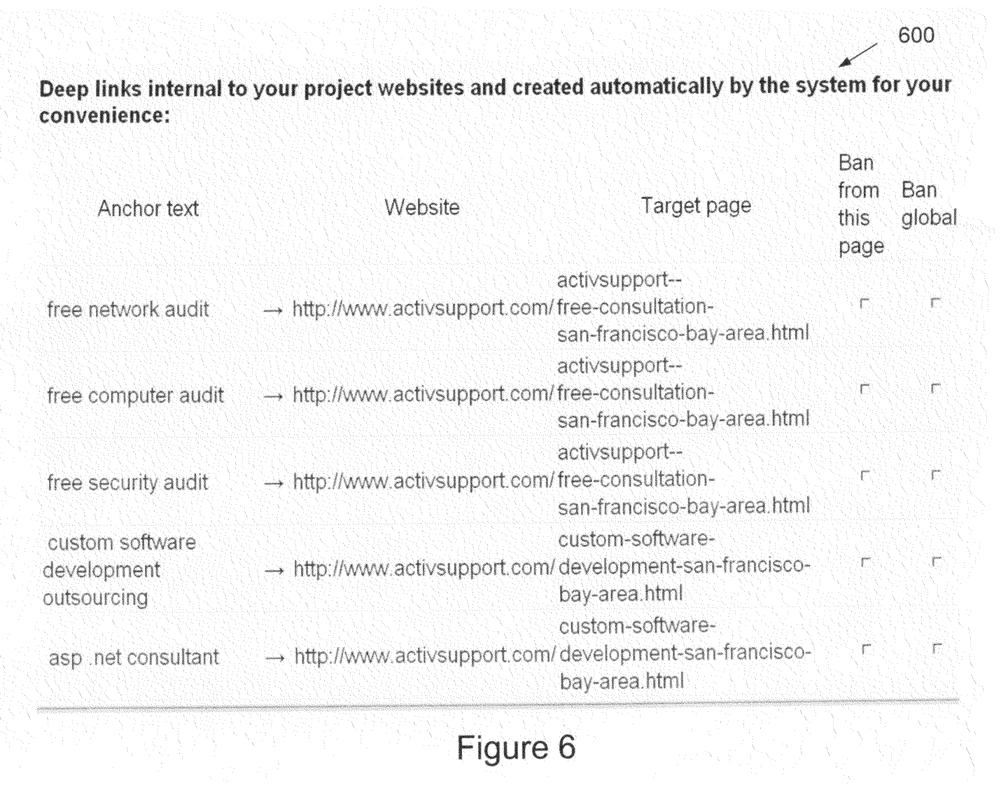

Attention is now drawn to FIGS. 4-6, which represent different user interfaces that the UI module 294 may present to a user when customizing data optimizer module 292 FIG. 4 includes multiple pull-down menus and checkboxes 400 that displays SEO execution features. FIG. 5 displays multiple pull-down menus and text boxes 500 that list client 130 sites, and software solution's variables and features available to construct SEO rules, and editable text boxes to further refine these rules. FIG. 6 comprises multiple table 600 that displays anchor texts and links to target pages, optimized partly based on parameters enabled using checkboxes 400, and created automatically throughout multiple client-pertinent sites by the software solution.

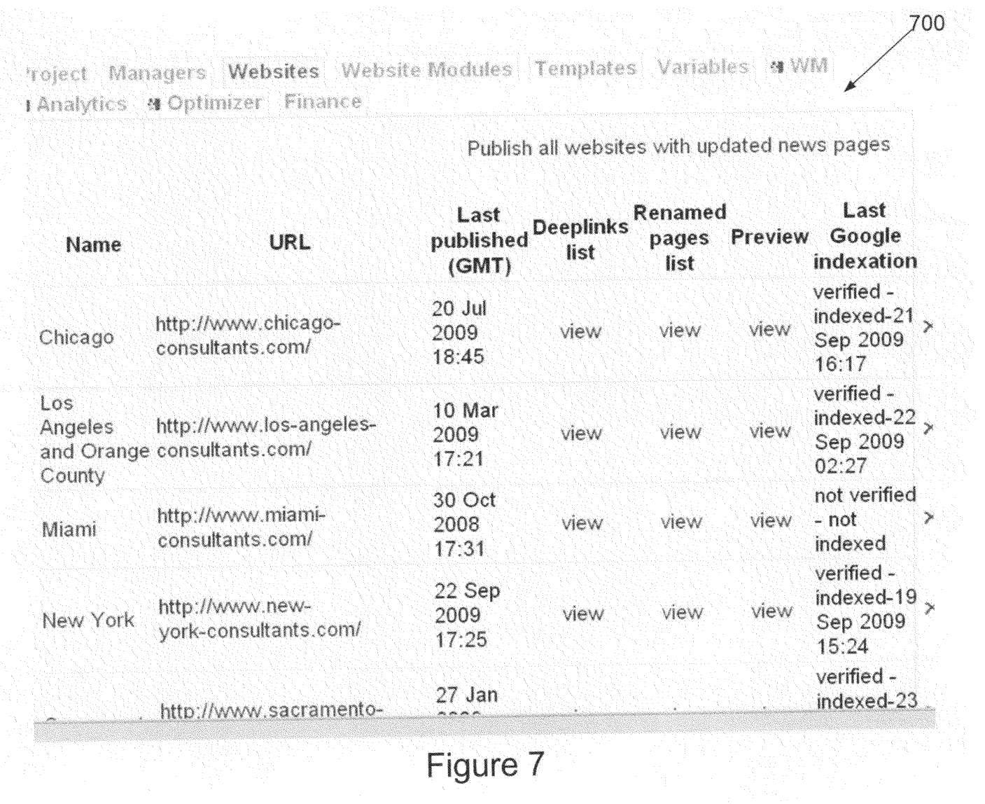

Attention is now drawn to FIG. 7, which represent different user interfaces that the UI module 294 may present to a user when representing client-pertinent executed operations developed during the linear and/or non-linear combinations described above with respect to the data optimizer module 292. FIG. 7 includes a table 700 that displays client-pertinent optimization operations and search engine indexation metrics with respect to multiple sites.

One of skill in the art will appreciate alternative embodiments wherein all or a portion of the optimized data generated by the data optimizer module 292 are accessible by one or more computer systems/visual displays external to the execution system 140 (e.g., via triggered or automatic emailing, widgets, or other methods within both the scope and spirit of the invention). One of skill in the art will also appreciate alternative embodiments in which the data optimizer module 292 executes one or more routines when triggering events occur (i.e., under preconfigured circumstances).

Client Architecture

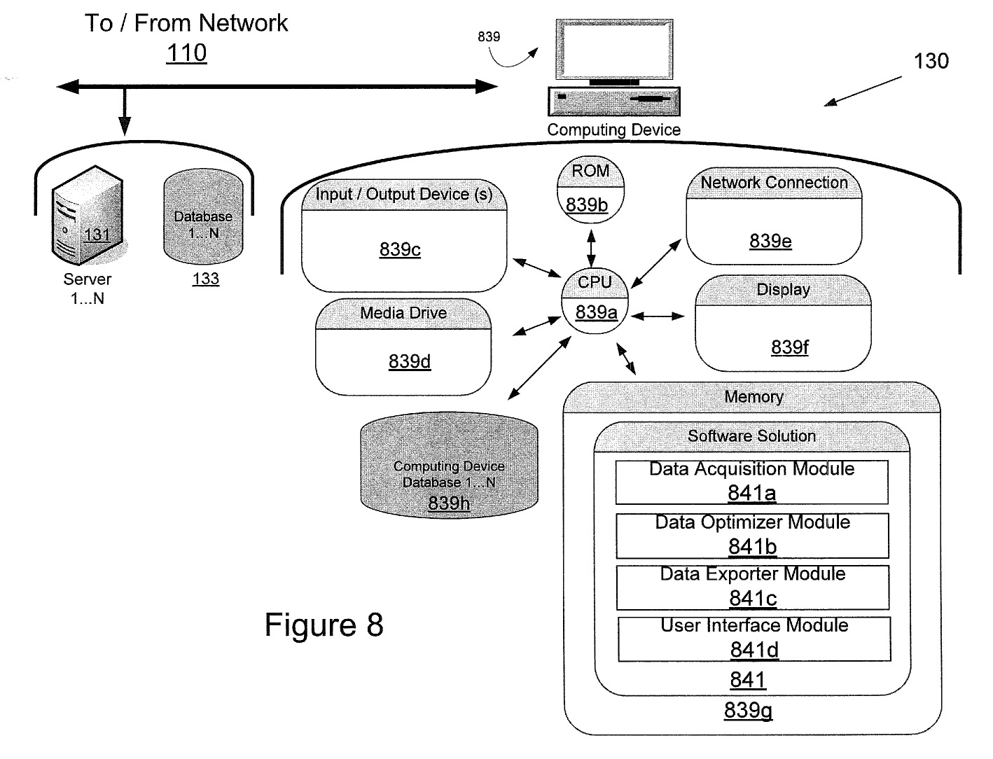

Attention is now drawn to FIG. 8, which depicts an exemplary implementation of the client 130. As is shown, the client 130 includes a server 131 connected to a database 133, both of which may communicate either directly or indirectly with the communication network 110. FIG. 8 also includes a computing device/system 839 configured in accordance with one implementation of the invention. The computing device 839 may include, but not by way of limitation, a personal computer (PC), a personal digital assistant (PDA), a cell phone, a television (TV), etc., or any other device configured to send/receive data to/from the communication network 110, such as consumer electronic devices and hand-held devices.

The implementation depicted in FIG. 8 includes a processor 839a coupled to ROM 839b, input/output devices 839c (e.g., a keyboard, mouse, etc.), a media drive 839d (e.g., a disk drive, USB port, etc.), a network connection 839e, a display 839f, memory 839g (e.g., random access memory (RAM)), and a file storage device 839h.

The storage device 839h is described herein in several implementations as a hard disk drive for convenience, but this is certainly not required, and one of ordinary skill in the art will recognize that other storage media may be utilized without departing from the scope of the invention. In addition, one of ordinary skill in the art will recognize that the storage device 839h, which is depicted for convenience as a single storage device, may be realized by multiple (e.g., distributed) storage devices.

As shown, a software solution 841 includes a data acquisition module 841a, a data optimizer module 841b, a data exporter module 841c, a user interface module 841d, all of which are implemented in software and are executed from the memory 839g by the processor 839a. The software 841 can be configured to operate on personal computers (e.g., handheld, notebook or desktop), servers or any device capable of processing instructions embodied in executable code. Moreover, one of ordinary skill in the art will recognize that alternative embodiments implementing one or more components in hardware are within the scope of the invention. Each module 841a-d functions similarly to modules 291, 292, 293 and 294, respectively, of FIG. 2.

The exemplary systems and methods of the invention have been described above with respect to the execution system 140 and/or the client 130. One of skill in the art will appreciate alternative embodiments wherein the functions of the execution system 140 are performed on other devices in the networked system 100.

Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

1. A method for modifying a web page to optimize the ranking of the modified web page in a listing of a search engine search results responsive to a key word query, the method comprising the steps of:
a) in a first computer system, acquiring data associated with the web page to be optimized;
b) in the first computer system, constructing a plurality of search engine optimization rules using as input the acquired data concerning the web page to be optimized, search engine optimization best practice rules, and acquired data concerning web pages other than the web page to be optimized;
c) in the first computer system, applying the plurality of constructed search engine optimization rules to the web page to be optimized to provide a modification of at least one parameter of the web page to be optimized; and,
d) in the first computer system, sending the modified web page to a second computer system associated with the publication of the web page.

2. The method of claim 1, wherein the step of constructing a plurality of search engine optimization rules includes generating a respective threshold to trigger and control execution of the search engine optimization rules.

3. The method of claim 1, wherein the step of constructing a plurality of search engine optimization rules using acquired data concerning web pages other than the web page to be optimized includes at least one data selected from the group consisting of identifying related industry, language, audience targeted geographical areas, web page content and web page concepts.

4. The method of claim 1, wherein the step of applying the plurality of these search engine optimization rules comprises applying automatically the constructed search engine optimization rules to the web page to be optimized and enabling user controls to provide fine-graining and override capabilities.

5. The method of claim 1, wherein the step of sending the modified web page comprises building, and/or uploading and/or exporting web page data from a system and/or interfacing between systems and publishing web server and/or published web pages data through an application programming interface.

6. The method of claim 1, wherein the step of acquiring data includes at least one data selected from the group consisting of (i) data related to content of the web page for indexing by one or more search engines; (ii) data related to traffic of one or more visitors to the web page; (iii) data related to search engine queries and statistics; (iv) data derived from one or more web page files; (v) data derived from a web analytics file; and (vi) data derived from a search engine queries file.

7. The method of claim 1, wherein step of acquiring data includes at least one data selected from the group consisting of (i) URL, URL keywords delimiter, Page Head Title tag, H1 tag, H2 Tag, H3 Tag, Page Header, Navigation menu name, Meta Keywords Tag, Meta Description Tag, Body Tag, Files Name, No Follow Tag, and A HREF Tag.

8. The method of claim 2, wherein the step of generating the respective threshold to trigger and control execution of the constructed search engine optimization rules comprises the step of determining whether a web page's URL, URL keywords delimiter, Page Head Title tag, H1 tag, H2 Tag, H3 Tag, Page Header, Navigation menu name, Meta Keywords Tag, Meta Description Tag, Body Tag, Files Name, No Follow Tag, and A HREF Tag are useful in the optimization of ranking web pages in a listing of search engine search results responsive to a key word query, and determining how often search engine optimization best practice rules should be applied.

9. The method of claim 1, wherein the step of constructing a plurality of search engine optimization rules includes determining how the web page's URL's are built using at least one data selected from the group consisting of URL keywords delimiter, Page Head Title tag, H1 tag, H2 Tag, H3 Tag, Page Header, Navigation menu name, Meta Keywords Tag, Meta Description Tag, Body Tag, Files Name, No Follow Tag, and A HREF Tag.

10. The method of claim 1, wherein the step of constructing a plurality of search engine optimization rules includes determining how the web page's Page Head Title tag is built using at least one data selected from the group consisting of URL, URL keywords delimiter, H1 tag, H2 Tag, H3 Tag, Page Header, Navigation menu name, Meta Keywords Tag, Meta Description Tag, Body Tag, Files Name, No Follow Tag, and A HREF Tag.

11. The method of claim 1, wherein the step of constructing a plurality of search engine optimization rules includes determining how the web page's H1's are built using at least one data selected from the group consisting of URL, URL keywords delimiter, Page Head Title tag, H2 Tag, H3 Tag, Page Header, Navigation menu name, Meta Keywords Tag, Meta Description Tag, Body Tag, Files Name, No Follow Tag, and A HREF Tag.

12. The method of claim 1, wherein the step of constructing a plurality of search engine optimization rules includes determining how a web page's H2's are built using at least one data selected from the group consisting of URL, URL keywords delimiter, Page Head Title tag, H1 Tag, H3 Tag, Page Header, Navigation menu name, Meta Keywords Tag, Meta Description Tag, Body Tag, Files Name, No Follow Tag, and A HREF Tag.

13. The method of claim 1, wherein the step of constructing a plurality of search engine optimization rules includes determining how a web page's H3's are built using at least one data selected from the group consisting of URL, URL keywords delimiter, Page Head Title tag, H1 Tag, H2 Tag, Page Header, Navigation title menu, Meta Keywords Tag, Meta Description Tag, Body Tag, Files Name, No Follow Tag, and A HREF Tag.

14. The method of claim 1, wherein the step of constructing a plurality of search engine optimization rules includes determining how a web page's Page Header's are built using at least one data selected from the group consisting of URL, URL keywords delimiter, Page Head Title tag, H1 tag, H2 Tag, H3 Tag, Navigation menu name, Meta Keywords Tag, Meta Description Tag, Body Tag, Files Name, No Follow Tag, and A HREF Tag.

15. The method of claim 1, wherein the step of constructing a plurality of search engine optimization rules includes determining how a web page's Navigation menu name's are built using data selected from the group consisting of URL, URL keywords delimiter, Page Head Title tag, H1 tag, H2 Tag, H3 Tag, Page Header, Meta Keywords Tag, Meta Description Tag, Body Tag, Files Name, No Follow Tag, and A HREF Tag.

16. The method of claim 1, wherein the step of constructing a plurality of search engine optimization rules includes determining how a web page's Meta Description Tag's are built using at least one data selected from the group consisting of URL, URL keywords delimiter, Page Head Title tag, H1 tag, H2 Tag, H3 Tag, Page Header, Navigation menu name, Meta Keywords Tag, Body Tag, Files Name, No Follow Tag, and A HREF Tag.

17. The method of claim 1, wherein the step of constructing a plurality of search engine optimization rules includes determining how a web page's Meta Keywords Tag's are built using at least one data selected from the group consisting of URL, URL keywords delimiter, Page Head Title tag, H1 tag, H2 Tag, H3 Tag, Page Header, Navigation menu name, Meta Description Tag, Body Tag, Files Name, No Follow Tag, and A HREF Tag.

18. The method of claim 1, wherein the step of constructing a plurality of search engine optimization rules includes determining how a web page's Body Tag's are built using at least one data selected from the group consisting of URL, URL keywords delimiter, Page Head Title tag, H1 tag, H2 Tag, H3 Tag, Page Header, Navigation menu name, Meta Description Tag, Meta Keywords Tag, Files Name, No Follow Tag, and A HREF Tag.

19. The method of claim 1, wherein the step of constructing a plurality of search engine optimization rules includes determining how a web page's Files Names are built using at least one data selected from the group consisting of URL, URL keywords delimiter, Page Head Title tag, H1 tag, H2 Tag, H3 Tag, Page Header, Navigation menu name, Meta Description Tag, Meta Keywords Tag, Body Tag, No Follow Tag, and A HREF Tag.

20. The method of claim 1, wherein the step of constructing a plurality of search engine optimization rules includes determining how a web page's No Follow Tags are built using at least one data selected from the group consisting of URL, URL keywords delimiter, Page Head Title tag, H1 tag, H2 Tag, H3 Tag, Page Header, Navigation menu name, Meta Description Tag, Meta Keywords Tag, Body Tag, Files Name, and A HREF Tag.

21. The method of claim 1, wherein the step of constructing a plurality of search engine optimization rules includes determining how a web page's A HREF Tags are built using at least one data selected from the group consisting of URL, URL keywords delimiter, Page Head Title tag, H1 tag, H2 Tag, H3 Tag, Page Header, Navigation menu name, Meta Description Tag, Meta Keywords Tag, Body Tag, Files Name, No Follow Tag.

22. The method of claim 3 wherein the step of constructing a plurality of search engine optimization rules using acquired data concerning web pages other than the web page to be optimized includes determining whether data concerning other web pages are suitable for combination with data concerning the web page to be optimized based on the closeness of their connection with the web page's industry.

23. The method of claim 3 wherein the step of constructing a plurality of search engine optimization rules using acquired data concerning web pages other than the web page to be optimized includes determining whether data concerning other web pages are suitable for combination with data concerning the web page to be optimized based on the language used within the potentially combinable web pages.

24. The method of claim 3 wherein the step of constructing a plurality of search engine optimization rules using acquired data concerning web pages other than the web page to be optimized includes determining whether data concerning other web pages are suitable for combination with data concerning the web page to be optimized based on based on the audience's targeted geographical area for the potentially combinable web pages.

25. The method of claim 3 wherein the step of constructing a plurality of search engine optimization rules using acquired data concerning web pages other than the web page to be optimized includes determining whether data concerning other web pages are suitable for combination with data concerning the web page to be optimized based on content found within the potentially combinable web pages.

26. The method of claim 3 wherein the step of constructing a plurality of search engine optimization rules using acquired data concerning web pages other than the web page to be optimized includes determining whether data concerning other web pages are suitable for combination with data concerning the web page to be optimized based on potentially combinable web page IP addresses.

27. The method of claim 3 wherein the step of constructing a plurality of search engine optimization rules using acquired data concerning web pages other than the web page to be optimized includes determining whether data concerning other web pages are suitable for combination with data concerning the web page to be optimized based on how the potentially combinable web pages' A HREF Tag's are built and reviewing the potentially combinable web pages' data using at least one data selected from the group consisting of URL, URL keywords delimiter, Page Head Title tag, H1 tag, H2 Tag, H3 Tag, Page Header, Navigation menu name, Meta Description Tag, Meta Keywords Tag, Body Tag, Files Name, No Follow Tag.

28. The method of claim 3 wherein the step of constructing a plurality of search engine optimization rules using acquired data concerning web pages other than the web page to be optimized includes determining whether data concerning other web pages are suitable for combination with data concerning the web page to be optimized based on how the potentially combinable web pages' No Follow Tag's are built and reviewing the potentially combinable web pages' data using at least one data selected from the group consisting of URL, URL keywords delimiter, Page Head Title tag, H1 tag, H2 Tag, H3 Tag, Page Header, Navigation menu name, Meta Description Tag, Meta Keywords Tag, Body Tag, Files Name, and A HREF Tag.

29. The method of claim 4, wherein the data associated with the web page includes data selected from the group consisting of URL, URL keywords delimiter, Page Head Title tag, H1 tag, H2 Tag, H3 Tag, Page Header, Navigation menu name, Meta Keywords Tag, Meta Description Tag, Body Tag, Files Name, No Follow Tag, A HREF Tag.

30. The method of claim 4 wherein enabling user controls further comprises presentation of a user interface that allows users to modify the modified data.

31. The method of claim 5, wherein the sending step does not require any real-time communication back to the first computer system once the modified web page has been sent to the second computer system.

32. A system for modifying a web page to optimize the ranking of the modified web page in a listing of search engine results responsive to a key word query, the system comprising:
at least one processor;
a network interface for receiving data from at least data source;
a memory, operationally coupled to the processor for storing logical instructions wherein execution of the logical instructions by the processor results in the performing of at least the following operations:
acquiring data associated with the web page to be optimized;
constructing a plurality of search engine optimization rules using as input the acquired data concerning the web page to be optimized, search engine optimization best practices, and acquired data concerning web pages other than the page to be optimized;
applying the plurality of constructed search engine optimization rules to the web page to be optimized to provide a modification of at least one parameter of the web page to be optimized; and,
sending the modified web page to a second system associated with publication of the web page.

33. The system of claim 32, wherein the operation of acquiring data comprises: building, and/or uploading and/or importing web page data into the system and/or interfacing between the system and web page data through an application programming interface.

34. The system of claim 32, wherein the operation of constructing a plurality of search engine optimization rules includes generating a respective threshold to trigger and control execution of the search engine optimization rules.

35. The system of claim 32, wherein the operation of constructing a plurality of search engine optimization rules using acquired data concerning web pages other than the web page to be optimized includes at least one data selected from the group consisting of identifying related industry, language, audience targeted geographical areas, web page content, and web page concept.

36. The system of claim 32, wherein the operation of applying the plurality of search engine optimization rules comprises applying automatically search engine optimization rules to the web page to be optimized and enabling user controls to provide fine-graining and override capabilities.

37. The system of claim 32, wherein the operation of sending the modified web page comprises building, and/or uploading and/or exporting web page data from a system and/or interfacing between a system and publishing web server and/or published web pages data through an application programming interface.

38. The system of claim 32, wherein the operation of acquiring data includes at least one data selected from the group consisting of (i) data related to content of the web page for indexing by one or more search engines; (ii) data related to traffic of one or more visitors to the web page; (iii) data related to search engine queries and statistics; (iv) data derived from one or more web page files; (v) data derived from a web analytics file; and, (vi) data derived from a search engine queries file.

39. The system of claim 34, wherein the operation of acquiring data includes at least one data selected from the group consisting of URL, URL keywords delimiter, Page Head Title tag, H1 tag, H2 Tag, H3 Tag, Page Header, Navigation menu name, Meta Keywords Tag, Meta Description Tag, Body Tag, Files Name, No Follow Tag, and A HREF Tag.

40. The system of claim 34, wherein the operation of generating the respective threshold to trigger and control execution of the constructed search engine optimization rules comprises the step of determining whether a web page's URL, URL keywords delimiter, Page Head Title tag, H1 tag, H2 Tag, H3 Tag, Page Header, Navigation menu name, Meta Keywords Tag, Meta Description Tag, Body Tag, Files Name, No Follow Tag, and A HREF Tag are useful in the optimization of ranking web pages in a listing of search engine search results responsive to a key word query, and determining how often search engine optimization best practice rules should be applied.

41. The system of claim 32, wherein the operation of constructing a plurality of search engine optimization rules comprises the step of determining how web page URL, URL keywords delimiter, Page Head Title tag, H1 tag, H2 Tag, H3 Tag, Page Header, Navigation menu name, Meta Description Tag, Meta Keywords Tag, Body Tag, Files Name, No Follow Tag, and A HREF Tag's are built using at least one data selected from the group consisting of URL, URL keywords delimiter, Page Head Title tag, H1 tag, H2 Tag, H3 Tag, Page Header, Navigation menu name, Meta Description Tag, Meta Keywords Tag, Body Tag, Files Name, No Follow Tag, and HREF Tag.

42. The system of claim 32, wherein the operation of constructing search engine optimization rules using data acquired about web pages other than the web page to be optimized includes determining whether data concerning other web pages are suitable for combination with data concerning the web page to be optimized based on at least one of the factors selected from the group consisting of the closeness to their connection with the web pages' industry, their audience's targeted geographical area, web pages' IP address, web pages' language and web pages' content.

43. The system of claim 35, wherein the operation of constructing search engine optimization rules using data acquired about web pages other than the web page to be optimized includes determining whether data concerning other web pages are suitable for combination with data concerning the web page to be optimized based on at least one of the factors selected from the group consisting of how the web pages' No Follow Tag and A HREF Tag's are built and web page's data selected from the group consisting of URL, URL keywords delimiter, Page Head Title tag, H1 tag, H2 Tag, H3 Tag, Page Header, Navigation menu name, Meta Description Tag, Meta Keywords Tag, Body Tag, Files Name, No Follow Tag, and A HREF Tag.

44. The system of claim 35, wherein the operation of acquiring data associated with the web page to be optimized includes at least one data selected from the group consisting of URL, URL keywords delimiter, Page Head Title tag, H1 tag, H2 Tag, H3 Tag, Page Header, Navigation menu name, Meta Keywords Tag, Meta Description Tag, Body Tag, Files Name, No Follow Tag, and A HREF Tag.

45. The system of claim 35, wherein the operation of enabling user controls comprises presentation of a user interface that allows users to modify the modified data.

46. The system of claim 35, wherein the operation of sending the modified web page does not require any real-time communication back to the system once the modified web page has been sent to the second computer system associated with the publication of the web page.

47. A method for exporting optimization data associated with a web page to optimize the ranking of the web page in a listing of a search engine search results responsive to a key word query, the method comprising the steps of:
a) in a first computer system, acquiring data associated with the web page;
b) in the first computer system, constructing a plurality of search engine optimization rules using as input the acquired data concerning the web page to be optimized, search engine optimization best practice rules, and acquired data concerning web pages other than the web page to be optimized;
c) in the first computer system, applying the plurality of constructed search engine optimization rules to the web page to be optimized to create optimization data associated with the web page to be optimized to be exported to at least one search engine; and,
d) in the first computer system, exporting to at least one search engine optimization data associated with the web page to be optimized.

48. A method for exporting optimized keyword data associated with a web page to optimize the ranking of the web page in a listing of a search engine search results responsive to a key word query, the method comprising the steps of:
a) in a first computer system, acquiring data associated with the web page;
b) in the first computer system, constructing a plurality of search engine optimization rules using as input the acquired data concerning the web page to be optimized, search engine optimization best practice rules, and acquired data concerning web pages other than the web page to be optimized;
c) in the first computer system, applying the plurality of constructed search engine optimization rules to the web page to be optimized to create optimized keyword data associated with the web page to be optimized to be exported to at least one search engine; and,
d) in the first computer system, exporting to at least one search engine optimized keyword data associated with the web page to be optimized.

49. A method for exporting to a social network web page optimized keyword data associated with a web page to optimize the ranking of the web page in a listing of a search engine search results responsive to a key word query, the method comprising the steps of:
a) in a first computer system, acquiring data associated with the web page;
b) in the first computer system, constructing a plurality of search engine optimization rules using as input the acquired data concerning the web page to be optimized, search engine optimization best practice rules, and acquired data concerning web pages other than the web page to be optimized;
c) in the first computer system, applying the plurality of constructed search engine optimization rules to the web page to be optimized to create optimization data associated with the web page to be optimized to be exported to at least one search engine; and,
d) in the first computer system, exporting to at least one social network web page optimization data associated with the web page to be optimized.
